(19) United States
(12) Patent Application Publication
(10) Pub. No.: US 2003/0189543 A1
(43) Pub. Date: Oct. 9, 2003

(54) Liquid crystal display device

(76) Inventors: Yoshiaki Nakayoshi, Ooamishirasato (JP); Kazuhiko Yanagawa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/395,398

(22) Filed: Mar. 25, 2003

(30) Foreign Application Priority Data
Apr. 9, 2002 (JP) 2002-106665

(51) Int. Cl. G09G 3/36

(52) U.S. Cl. 345/98

(57) ABSTRACT

The present invention resolves a drawback attributed to charging up of a charge to another substrate which faces one substrate on which pixel electrodes and counter electrodes are formed in an opposed manner. In a liquid crystal display device which includes a pixel electrode and a counter electrode which generates an electric field between the counter electrode and the pixel electrode in each pixel region on a liquid-crystal-side surface of one of respective substrates which are arranged to face each other by way of liquid crystal, a voltage supplied to the counter electrode is a voltage which is sharply changed after starting of display by the liquid crystal display device and, thereafter, assumes a stationary state.

### BACKGROUND OF THE INVENTION

1. Field of the Invention

The present invention relates to a liquid crystal display device, and more particularly to a so-called lateral electric field type liquid crystal display device.

2. Description of the Related Art

In a so-called lateral electric field type liquid crystal display device, on respective pixel regions formed on a surface of a liquid crystal side of one substrate out of respective substrates which are arranged to face each other by way of liquid crystal, pixel electrodes which are arranged close to each other and counter electrodes are arranged and the optical transmissivity of the liquid crystal is controlled in response to components parallel to the substrates out of electric fields which are generated between respective electrodes.

In a liquid crystal display device in which such a constitution is adopted in an active matrix type, on a liquid crystal side surface of the above-mentioned one substrate, a plurality of gate signal lines which are arranged in parallel and a plurality of drain signal lines which cross these gate signal lines and are arranged in parallel are formed, and respective regions which are surrounded by respective signal lines constitute the pixel regions.

Then, on each pixel region, a switching element which is operated by a scanning signal from the gate signal line, the pixel electrode to which a video signal is supplied from the drain signal line through the switching element, and the counter electrode to which a reference signal is supplied from a counter voltage signal line are formed.

### SUMMARY OF THE INVENTION

However, inventors of the present invention have found the following. In the liquid crystal display device having such a constitution, a portion of a line of electric force between the pixel electrode and the counter electrode is generated in an arc shape such that the portion reaches another transparent substrate side. Accordingly, there arises a phenomenon that a color filter, other material layer or the like formed on a liquid-crystal-side surface of another transparent substrate is charged up with a charge and hence, with respect to a so-called Vcom voltage supplied to the counter electrode, a value of the suitable Vcom voltage is changed along with the lapse of time.

FIG. 2 is graph showing that a value of the suitable Vcom voltage is changed along with the lapse of time, wherein the lapse of time (minute) from starting of display is taken on an axis of abscissas and the suitable Vcom voltage (V) is taken on an axis of ordinates.

Such a graph is obtained by measuring a value of the suitable Vcom voltage at which a flicker is minimized, for example, by changing the Vcom voltage every time period. Here, samples A, B are selected as subjects for measurement.

As can be understood from the drawing, first of all, it is apparent that the respective change characteristics have converging voltages after a given lapse of time from starting of display.

Then, although the time until the Vcom reaches the converging voltage differs depending on samples, it is considered that the difference reflects the difference in specific resistance of the liquid crystal material.

Here, although not shown in the graph, as a result of also measuring drift quantities of the suitable Vcom voltage at respective points in a display region surface, it has been apparent that the drift quantities are substantially equal as a whole although there exists the difference of approximately 20 mV.

Compared to the fact that the suitable Vcom voltage assumes different values based on the influence of respective waveform delays through the gate signal line, the drain signal line and the counter voltage signal line in the display region surface, this can be understood as a unique phenomenon.

Further, since this phenomenon degrades the quality of display, a countermeasure to cope with this phenomenon is requested.

The present invention has been made in view of these circumstances and it is an advantage of the present invention to provide a liquid crystal display device which can solve drawbacks caused by charging up of a charge on another substrate which faces a substrate on which pixel electrodes and counter electrodes are formed in an opposed manner.

To briefly explain the summary of typical inventions among inventions disclosed by the present application, they are as follows.

(1) In a liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, the liquid crystal display device further includes a control circuit which controls a voltage signal supplied to the counter electrode by taking a charge quantity which is charged to another substrate side out of the respective substrates by an electric field generated between the pixel electrode and the counter electrode into consideration.

(2) In a liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, the liquid crystal display device further includes a control circuit which controls a voltage signal supplied to the counter electrode, and the control circuit supplies a voltage signal set based on the influence of a charge quantity charged to another substrate side out of the respective substrates to the counter electrode.

(3) In a liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, the liquid crystal display device further includes a control circuit which controls a voltage signal supplied to the counter electrode, and using preset data indicative of a suitable voltage signal, the control circuit supplies a voltage signal which approximates the suitable voltage signal to the counter electrode.

(4) In a liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, a voltage supplied to the counter electrode is a voltage which is sharply changed after starting of display by the liquid crystal display device and, thereafter, assumes a stationary state.

(5) In a liquid crystal display device in which a pixel electrode to which a video signal is supplied and a counter electrode to which a signal constituting the reference with respect to the video signal is supplied are formed on each one of respective pixel regions arranged in a matrix array, the liquid crystal display device further includes light detection means which detects the intensity of light which is transmitted to the pixel region and control means which changes a voltage value of a signal supplied to the counter electrode in response to an output from the light detection means.

(6) In the constitution (5), the light detection means is arranged such that the light detection means faces a region adopting a constitution similar to the constitution of the pixel region in an opposed manner, and detects the intensity of light which is transmitted through the region.

(7) In the constitution (5), a voltage of the counter electrode is changed and a next counter voltage is set in response to a change of luminance which is generated at the time of changing the voltage of the counter electrode.

(8) In the constitution (5), the pixel electrode and the counter electrode are formed on the same substrate.

(9) In the constitution (7), the pixel electrode and the counter electrode are formed on the same substrate.

(10) In a liquid crystal display device in which respective substrates are arranged in an opposed manner by way of liquid crystal and a pixel electrode and a counter electrode are formed on each one of pixel regions formed on a liquid crystal side of one substrate out of the respective substrates, at least on a liquid-crystal-side surface of another substrate out of the respective substrates, an orientation film whose specific resistance is set to a value which falls within a range of 1×10⁹ Ωcm to 1×10¹³ Ωcm is formed.

(11) In the constitution (10), on a liquid-crystal-side surface of the one substrate, an orientation film whose specific resistance is set to a value which falls within a range of 1×10⁹ Ωcm to 1×10¹³ Ωcm is formed.

(12) In the constitution (11), conductive support columns are arranged between the orientation films which are formed on one and another substrates.

(13) In a liquid crystal display device in which a pair of substrates which are arranged in an opposed manner by way of liquid crystal are provided, pixel electrodes and counter electrodes which generate an electric field by way of the liquid crystal are provided, and a potential of the pixel electrodes is set such that a video signal is supplied to video signal lines from a video signal driving circuit by way of thin film transistors in response to a scanning signal which is supplied to scanning signal lines from a scanning signal driving circuit, the video signal driving circuit and the scanning signal driving circuit are controlled in response to signals from a controller, and the liquid crystal display device further includes a D/A converter which generates a counter voltage supplied to the counter electrodes in response to the signals from the controller.

(14) In the constitution (13), a Low voltage supplied to the D/A converter is higher than the lowest voltage supplied to the video signal driving circuit, and a High voltage supplied to the D/A converter is lower than the highest voltage supplied to the video signal driving circuit.

(15) In the constitution (13), a current amplifying circuit is provided between the D/A converter and the counter electrodes.

(16) In the constitution (13), the pixel electrodes and the counter electrodes are formed on the same substrate.

(17) In the constitution (16), the counter voltage is controlled by taking a charge quantity charged to another substrate side out of the respective substrates due to an electric field generated between the pixel electrodes and the counter electrodes into account.

(18) In the constitution (16), the counter voltage is served for supplying a voltage signal set in view of the influence of a charge quantity charged to another substrate side out of the respective substrates to the counter electrodes.

(19) In the constitution (16), the counter voltage is a voltage which is generated using preset data indicative of a suitable voltage signal such that the counter voltage approximates the suitable voltage signal.

(20) In the constitution (16), the liquid crystal display device includes light detection means which detects the intensity of light which is transmitted through the liquid crystal display device and control means which changes a voltage value of a signal supplied to the counter electrodes in response to an output from the light detection means.

Here, the present inventions are not limited to the above-mentioned constitutions and various modifications can be made without departing from the technical concep of the present invention.

### BRIEF DESCRIPTION OF THE DRAWINGS

FIG. 1 is a constitutional view showing one embodiment of a liquid crystal display device according to the present invention and also is a flow chart showing an operation of a TCON.

FIG. 2 is a view showing one embodiment of a comparison data table shown in FIG. 1 constituting a view showing the relationship between a time elapsed from starting of display and a suitable Vcom voltage.

FIG. 3 is a view showing the whole constitution of one embodiment of a liquid crystal display device according to the present invention.

FIG. 4 is an explanatory view showing one embodiment of a control method of a TCON shown in FIG. 3.

FIG. 5 is a view showing the whole constitution of another embodiment of a liquid crystal display device according to the present invention.

FIG. 6 is a view showing the whole constitution of still another embodiment of a liquid crystal display device according to the present invention.

FIG. 7 is a constitutional view showing one embodiment of the constitution of a pixel region in a liquid crystal display device according to the present invention.

FIG. 8 is a plan view showing another embodiment of the constitution of a pixel region in a liquid crystal display device according to the present invention.

FIG. 9 is a view showing the whole constitution of a further embodiment of a liquid crystal display device according to the present invention.

FIG. 10 is a cross-sectional view showing a still further embodiment of a liquid crystal display device according to the present invention.

FIG. 11 is a cross-sectional view showing a still further embodiment of a liquid crystal display device according to the present invention.

FIG. 12 is an operational view showing a circuit of the still further embodiment of a liquid crystal display device according to the present invention.

FIG. 13 is a cross-sectional view showing a still further embodiment of a liquid crystal display device according to the present invention.

FIG. 14 is a cross-sectional view showing a still further embodiment of a liquid crystal display device according to the present invention.

FIG. 15 is a view showing the whole constitution of a still further embodiment of a liquid crystal display device according to the present invention.

FIG. 16 is a view showing the detailed constitution of a particular pixel shown in FIG. 15.

FIG. 17 is a view showing the constitution of another embodiment of a pixel of a liquid crystal display device according to the present invention.

FIG. 18 is a view showing the constitution of still another embodiment of a pixel of a liquid crystal display device according to the present invention.

FIG. 19 is a view showing the constitution of a further embodiment of a pixel of a liquid crystal display device according to the present invention.

FIG. 20 is a view showing the constitution of a still further embodiment of a pixel of a liquid crystal display device according to the present invention.

FIG. 21 is a view showing the constitution of a still further embodiment of a pixel of a liquid crystal display device according to the present invention.

FIG. 22 is a cross-sectional view showing a still further embodiment of a liquid crystal display device according to the present invention.

FIG. 23 is a constitutional view showing a still further embodiment of a pixel of a liquid crystal display device according to the present invention.

### DESCRIPTION OF THE PREFERRED EMBODIMENTS

Preferred embodiments of a liquid crystal display device according to the present invention are explained hereinafter in conjunction with drawings.

Embodiment 1

As shown in FIG. 2, a value of a suitable Vcom voltage for the liquid crystal display device is changed along with the lapse of time. Accordingly, by approximating a counter voltage applied to counter electrodes to this suitable Vcom voltage, it is possible to obviate a drawback caused by the change of the suitable Vcom voltage.

In one simple technique, the counter voltage applied to the counter electrodes is preliminarily set such that the counter voltage is sharply changed after starting of display by the liquid crystal display device and, thereafter, the counter voltage assumes a stationary state. Due to such a control, as shown in FIG. 2, against the change of the suitable Vcom voltage, it is possible to reduce the deviation of the counter voltage from the suitable Vcom voltage than that of a case in which the counter voltage is always fixed so that the reduction of adverse influences attributed to the change of the suitable Vcom voltage can be realized.

Then, an embodiment which can reduce the deviation of the counter voltage more effectively is explained in detail.

<<Entire Constitution>>

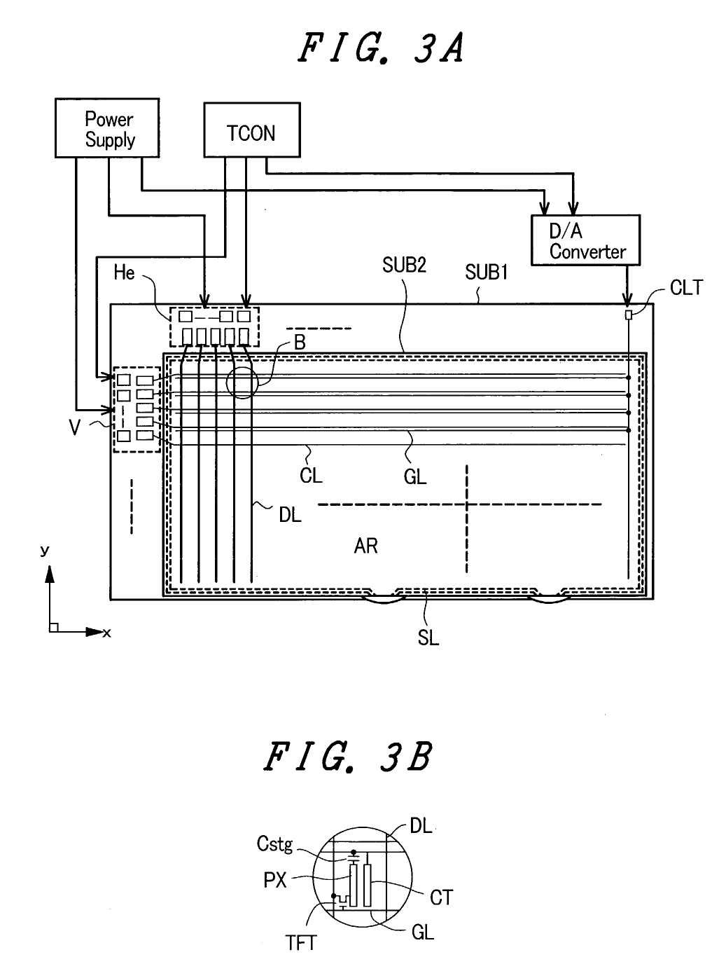

FIG. 3 is a view showing the whole constitution of one embodiment of the liquid crystal display device according to the present invention. Although the view is illustrated as an equivalent circuit, the view is prepared corresponding to an actual geometric arrangement of the liquid crystal display device.

In the drawing, there are provided a pair of transparent substrates SUB1, SUB2 which are arranged in an opposed manner by way of liquid crystal. The liquid crystal is sealed by a sealing member SL which also performs a function of fixing another transparent substrate SUB2 to one transparent substrate SUB1.

On a liquid-crystal-side surface of the above-mentioned one transparent substrate SUB1 which is surrounded by the sealing member SL, gate signal lines GL which extend in the X direction and are arranged in parallel in the y direction and drain signal lines DL which extend in the y direction and are arranged in parallel in the X direction are formed.

Regions which are surrounded by respective gate signal lines GL and respective drain signal lines DL constitute pixel regions and, at the same time, a mass of these respective pixel regions in a matrix array constitute a liquid crystal display part AR.

Further, in respective pixel regions which are arranged in parallel in the X direction, common counter voltage signal lines CL which run in respective pixel regions are formed. These counter voltage signal lines CL constitute signal lines which supply a counter voltage (Vcom) which becomes the reference with respect to a video signal to counter electrodes CT of respective pixel regions which will be explained later.

In each pixel region, a thin film transistor TFT which is operated in response to the scanning signal from the one-side gate signal line GL and a pixel electrode PX to which the video signal is supplied from the one-side drain signal line DL through the thin film transistor TFT are formed.

The pixel electrode PX is configured to generate an electric field between the pixel electrode PX and the counter electrode CT which is connected to the above-mentioned counter voltage signal line CL and controls the optical transmissivity of the liquid crystal due to this electric field.

Respective one ends of the gate signal lines GL are extended across the sealing member SL and extended ends constitute terminals to which output terminals of a scanning signal driving circuit V are connected. Further, to an input terminal of the scanning signal driving circuit V, signals from a printed circuit board which is arranged outside the liquid crystal display panel are inputted.

The scanning signal driving circuit V is constituted of a plurality of semiconductor devices, wherein a plurality of gate signal lines GL which are arranged to close to each other are formed into a group and one semiconductor device is allocated to each group of gate signal lines GL.

In the same manner, respective one ends of the drain signal lines DL are extended across the sealing member SL and extended ends constitute terminals to which output terminals of a video signal driving circuit He are connected. Further, to an input terminal of the video signal driving circuit He, signals from a printed circuit board which is arranged outside the liquid crystal display panel are inputted.

The video signal driving circuit He is also constituted of a plurality of semiconductor devices, wherein a plurality of drain signal lines DL which are arranged close to each other are formed into a group and one semiconductor device is allocated to each group of drain signal lines DL.

Further, the counter voltage signal lines CL which are common with respect to respective pixel regions arranged in parallel in the X direction have right-side ends thereof in the drawing connected in common to a connection line, while the connection line is extended across the sealing member SL and an extended end constitutes a terminal CLT. A voltage which constitutes the reference with respect to the video signal is supplied to the connection line from the terminal CLT.

With respect to respective gate signal lines GL, one gate signal line GL is selected in response to each scanning signal supplied from the scanning signal driving circuit V sequentially.

Further, to respective drain signal lines DL, the video signals are supplied from the video signal driving circuit He in accordance with timing of selecting the gate signal lines GL.

Still further, a Vcom signal is supplied to the terminal CLT of the counter voltage signal line CL from the D/A converter and the Vcom signal constitutes a signal whose voltage value is controlled along with the lapse of time.

Here, a power supply and control signals are respectively supplied to a D/A converter, the scanning signal driving circuit V and the video signal driving circuit He from a power supply circuit and the TCON.

<<D/A Converter>>

The voltage Vcom supplied to the counter voltage signal lines CL is formed through the D/A converter which is controlled in response to digital data from the TCON and hence, it is possible to control the voltage Vcom corresponding to the change thereof along with the lapse of time.

Further, a voltage for driving the D/A converter can be formed independently from the video signal driving circuit He or the scanning signal driving circuit V and the control of the above-mentioned voltage Vcom can be performed at a fine interval.

For example, the number of division of an output voltage of the D/A converter is determined based on the number of bits of the D/N converter and hence, only 64 gray scales can be obtained by division with respect to 6 bits and only 256 gray scales can be obtained by division with respect to 8 bits. Accordingly, it is difficult to perform the delicate control compatible to an analogue control. Here, with respect to the video signal driving circuit He, assuming the number of bits as 8 bits, when the potential difference from 0V to 12V is divided by 256, the potential difference per one gray scale becomes about 47 mV and hence, the delicate control cannot be performed. On the other hand, with respect to the suitable Vcom voltage, the control with a unit potential difference of 10 mV is required.

Accordingly, in this embodiment, the voltage for driving the D/A converter is set to a value different from the voltage supplied to the video signal driving circuit He or the scanning signal driving circuit V.

That is, with respect to the supply voltage to the D/A converter, a Low voltage thereof is set higher than a Low voltage of the power supply to the video signal driving circuit He and a High voltage thereof is set lower than a High voltage of the power supply to the video signal driving circuit He.

For example, assuming the Low voltage and the High voltage of the power supply to the D/A converter as 4V and 5V respectively, when the potential difference is divided by 256, it is possible to output 4 mV per one gray scale so that the accuracy can be enhanced 10 times.

In this case, it is preferable to set the potential difference between the Low voltage and the High voltage of the power supply to the D/A converter to not more than 1V. This is because that a drift amount of the voltage Vcom can be designed such that the amount can be suppressed to a value not more than 1V and hence, the accuracy can be enhanced.

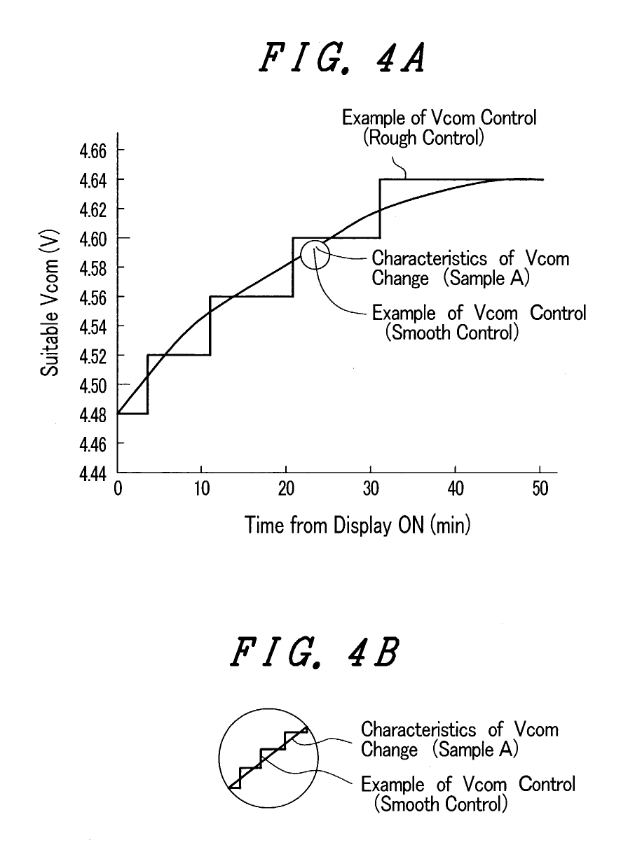

FIG. 4 is a graph indicating a control example of the suitable Vcom voltage and shows that a smooth control, a rough control and an intermediate control can be performed.

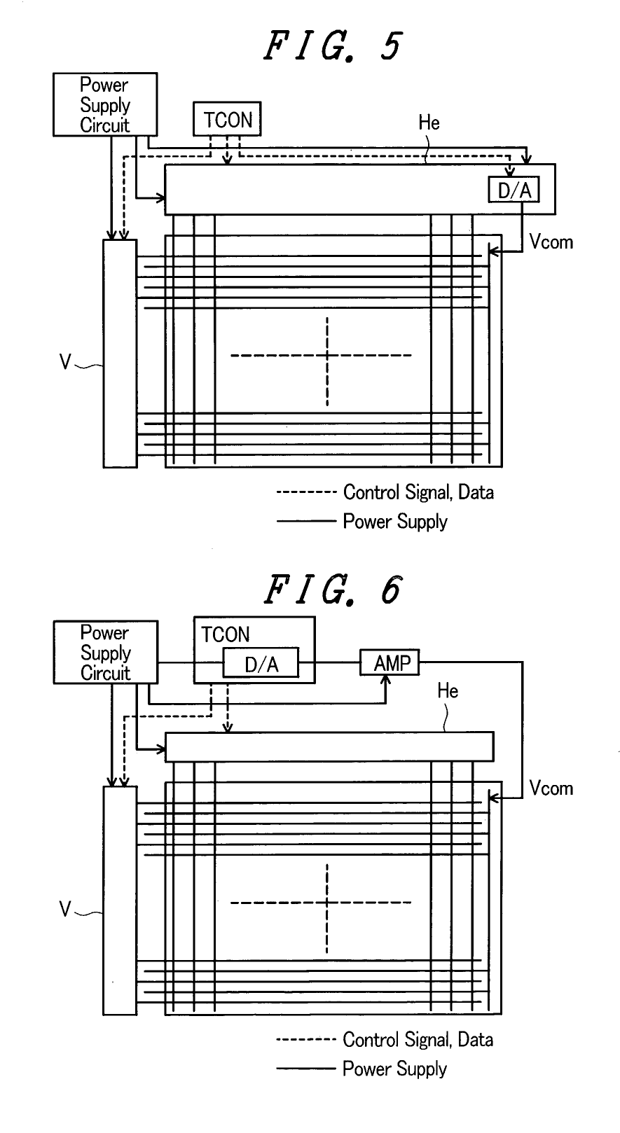

FIG. 5 shows another embodiment of the D/A converter and also shows the D/A converter in a state that the D/A converter is incorporated into the video signal driving circuit He. In this case, the power supply to the D/A converter and the power supply to the video signal driving circuit He may be formed separately. Here, the D/A converter may be either of a so-called resistance division type or of a current amplifying type.

Further, FIG. 6 shows another example of the D/A converter and also shows the D/A converter in a state that the D/A converter is incorporated into the TCON. This constitution can be realized since a circuit scale of the D/A converter is relatively small.

Since the video signal driving circuit He is usually constituted such that one semiconductor integrated circuit is allocated to a plurality of neighboring drain signal lines DL, the D/A converter can be easily incorporated in the TCON in circuit designing.

In this case, when the current supply ability of the D/A converter in the TCON is increased, in spite of the fact that a logic system other than the D/A converter necessitates no high current supply ability, it is necessary to produce the TCON in a process which increases the current supply ability of the whole TCON and hence, it is difficult to miniaturize the chip size of the TCON.

Accordingly, it is preferable that a current amplifying circuit AMP is externally added so as to supply the voltage Vcom through a current amplifying circuit AMP.

Since an input/output gain of the voltage of the current amplifying circuit AMP is substantially 1, the current amplifying ability of the D/A converter is determined by the discrete current amplifying circuit AMP. Accordingly, the current amplifying ability is enhanced so that the Vcom voltage is hardly influenced by the change of load attributed to the difference in a display pattern of the liquid crystal display device whereby the Vcom can be made stable.

<<Flow Chart>>

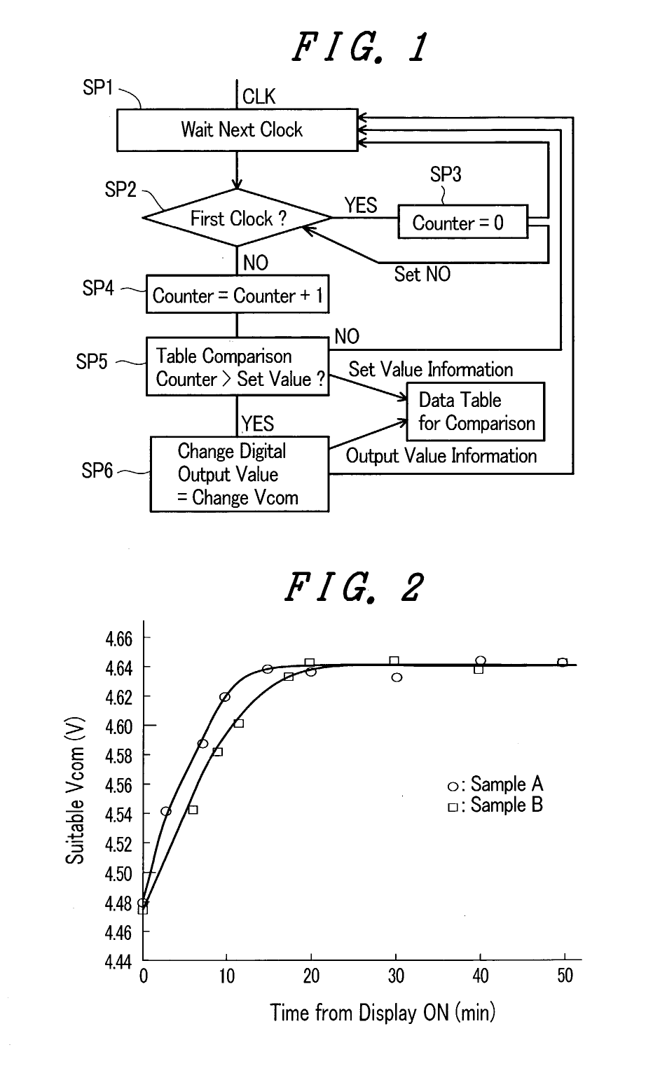

FIG. 1 is a flow chart of one embodiment in which the voltage Vcom supplied to the counter voltage signal lines CL is subjected to a time-sequential control using data obtained from the graph shown in FIG. 2 as a data table for comparison purpose, for example. This control is performed by the TCON.

First of all, in step 1 (SP1), a clock signal CLK is inputted. As the clock signal CLK, a start pulse of the scanning signal or the like, for example, can be preferably used. One start pulse is obtained with respect to scanning of one screen. Accordingly, in the driving at 60 Hz, the number of start pulses assumes 60 in one second, 3600 in one minute and 36000 in 10 minutes.

When a counter is constituted in 16 bits, the counter can count up to 65536 and hence, the counter sufficiently can count until 10 minutes elapses. Further, with the use of such a counter, it is possible to obviate the increase of the circuit scale of the TCON.

In step 2 (SP2), it is judged whether the clock signal CLK is the first clock or not. When the clock signal CLK is the first clock, a value of the counter is set to 0 in step 3 and, thereafter, it is set that the clock signal is not the first clock signal in step 2 (SP2). Then, the processing is made to wait until a next clock (pulse edge) is inputted.

When the next clock is supplied, 1 is added to the present count value in step 4 (SP4).

Then, in step 5 (SP5), the present count value is compared with a set value of the table. Here, the table is a data table for comparison and corresponds to the graph shown in FIG. 2. In this case, when the count value is below the set value in the table, the processing is made to wait until the next clock is inputted in step 1.

When the count value exceeds the set value in the table, in step 6 (SP6), a digital output value of the D/A converter is changed so that the value of the Vcom voltage is changed.

Thereafter, the processing waits the inputting of next clock in step 1 and the above-mentioned processing is repeated hereinafter.

In this case, in a stage that the number of clock signals exceeds the range of the counter, the Vcom is in a stationary state as shown in FIG. 2 and there arises no problem with respect to an overflow at certain point of time.

Further, in case that the frame frequency is changed, when the D/A converter is driven at 100 Hz, for example, an actual lapsed time due to counting with the start pulse differs from an actual lapsed time when the D/A converter is driven at 60 Hz. Accordingly, at the time of performing the comparison with the table, it is preferable to change or convert reading of the value on the table in response to the frame frequency per unit time.

The reason is that the Vcom drift phenomenon depends on the actual time and the dependency to frequency is hardly observed. Another reason is that the state of the storage of charge is determined by liquid crystal or the substrates or the like and hence, the dependency to the frame frequency is extremely small.

<<Constitution of Pixel>>

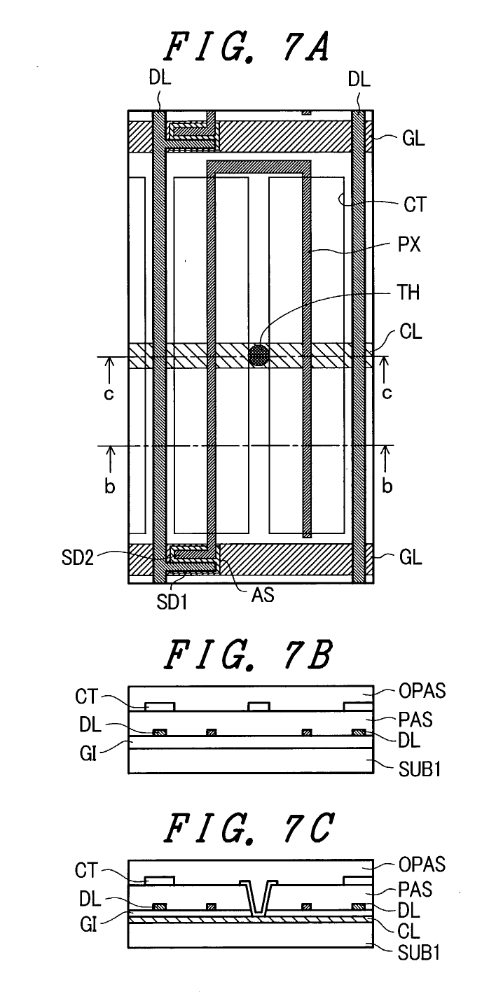

FIG. 7A is a plan view showing one embodiment of the constitution of the pixel region of the liquid crystal display device shown in FIG. 3. Further, FIG. 7B is a cross-sectional view taken along a line b-b of FIG. 7A and FIG. 7C is a cross-sectional view taken along a line c-c of FIG. 7A.

First of all, on the liquid-crystal-side surface of the transparent substrate SUB1, a pair of gate signal lines GL which extend in the X direction and are arranged in parallel in the y direction are formed.

These gate signal lines GL surround a rectangular region together with a pair of drain signal lines DL which will be explained later and this region constitutes the pixel region.

Further, the counter voltage signal line CL which is arranged parallel to the gate signal lines Gl is formed at the center portion between respective gate signal lines GL, for example. The counter voltage signal line CL is formed simultaneously at the time of forming the gate signal lines GL, for example, and is made of material having small electric resistance.

On the surface of the transparent substrate SUB1 on which the gate signal lines GL and counter voltage signal lines CL are formed, an insulation film GI which is made of SiN, for example, is formed such that the insulation film GI covers the surface of the transparent substrate SUB1 including the gate signal lines GL and the like.

The insulation film GI performs a function of an interlayer insulation film with respect to the gate signal lines GL and the counter voltage signal lines CL in regions explained later where the drain signal lines DL are formed and a function of a gate insulation film in regions explained later where the thin film transistors TFT are formed.

Then, on a surface of the insulation film GI, a semiconductor layer AS made of amorphous Si, for example, is formed such that the semiconductor layer AS overlaps a portion of the gate signal line GL.

The semiconductor layer AS constitutes a part of the thin film transistor TFT, wherein by forming a drain electrode SD1 and a source electrode SD2 on the semiconductor layer AS, it is possible to constitute a MIS (metal insulator semiconductor) having an inverse staggered structure which forms the gate electrode by a portion of the gate signal line.

Here, the drain electrode SD1 and the source electrode SD2 are formed simultaneously with the formation of the drain signal lines DL.

That is, the drain signal lines DL which extend in the y direction and are arranged in parallel in the X direction are formed and a portion of the drain signal line DL is extended to a position above an upper surface of the semiconductor layer AS so as to form the drain electrode SD1. Further, the source electrode SD2 is formed in a spaced apart manner from the drain electrode SD1 by a length of a channel of the thin film transistor TFT.

The source electrode SD2 is integrally formed with the pixel electrode PX which is formed in the pixel region.

That is, the pixel electrode PX is constituted of a group of electrodes consisting of a plurality of (two in the drawing) electrodes which extend in the y direction and are arranged in parallel in the X direction in the pixel region. In such a constitution, one end portion of the one pixel electrode PX also functions as the source electrode SD2 and an electrical connection is established between another end portion of the pixel electrode and a corresponding portion of another pixel electrode PX.

On the surface of the transparent substrate SUB1 on which the thin film transistor TFT, the drain signal line DL, the drain electrode SD1, the source electrode SD2 and the pixel electrode PX are formed in the above-mentioned manner, a protective film PAS is formed. The protective film PAS is provided for obviating a direct contact of the thin film transistor TET and the liquid crystal and can prevent the degradation of the characteristics of the thin film transistor TFT.

Here, the protective film PAS is formed of an organic material layer such as resin or is formed of a sequential laminate body which is constituted of an inorganic material layer such as SiN and an organic material layer such as resin. The reason that at least the organic material layer is used in forming the protective film PAS lies in that the dielectric constant of the protective film per se can be reduced.

A counter electrode CT is formed on an upper surface of the protective film PAS. The counter electrode CT is formed of a group of electrodes consisting of a plurality of (three in the drawing) electrodes which extend in the y direction and are arranged in parallel in the X direction in the same manner as the previously-mentioned pixel electrodes PX. These respective electrodes are configured such that each electrode is positioned between the pixel electrodes PX in a plan view.

That is, the counter electrodes CT and the pixel electrodes PX are arranged in the order of the counter electrode, the pixel electrode, the counter electrode, the pixel electrode, . . . counter electrode from the one-side drain signal line to another-side drain signal line in an equally spaced-apart manner respectively.

Here, the counter electrodes CT which are positioned at both sides of the pixel region have portions thereof overlapped to the drain signal lines DL and are formed in common with the counter electrodes CT corresponding to the neighboring pixel region.

In other words, the counter electrodes CT are overlapped to the drain signal lines DL such that their center axes are substantially aligned with each other and a width of the counter electrodes is set larger than a width of the drain signal lines DL. The counter electrode CT disposed at the left side with respect to the drain signal line DL constitutes one of respective counter electrodes CT in the left-side pixel region, while the counter electrode CT disposed at the right side with respect to the drain signal line DL constitutes one of respective counter electrodes CT in the right-side pixel region.

In this manner, by forming the counter electrodes CT having the width larger than the width of the drain signal lines DL over the drain signal lines DL, it is possible to obtain an advantageous effect that lines of electric force from the drain signal lines DL terminate at the counter electrodes CT and the drain signal lines DL are prevented from terminating to the pixel electrodes PX. That is, when the lines of electric force from the drain signal lines DL terminate at the pixel electrodes PX, this gives rise to noises.

Respective counter electrodes CT which constitute a group of electrodes are integrally formed with the same material layer which is formed such that the layer sufficiently covers the gate signal lines GL. Further, respective counter electrodes CT are electrically connected with the counter voltage signal line CL via through holes TH which penetrate the protective film PAS and the insulation film GI.

Here, by forming respective counter electrodes CT and the above-mentioned material layer integrally formed with the counter electrodes CT using a light-transmitting conductive layer such as ITO (Indium Tin Oxide), ITZO (Indium Tin Zinc Oxide), IZO (Indium Zinc Oxide), SnO₂ (Tin Oxide), IN₂O₃ (Indium Oxide) or the like, it is possible to enhance the numerical aperture of the pixel.

With respect to the material layer which is formed integrally with the counter electrodes CT formed in a state that the counter electrodes CT sufficiently cover the gate signal lines GL, below portions of the material layer which are projected from the gate signal lines GL, connection portion which connect them with respective pixel electrodes PX are positioned whereby capacitive elements Cstg which use the protective film PAS as a dielectric film are formed between the pixel electrodes PX and the counter electrodes CT.

The capacitive element Cstg is configured to perform several functions including, for example, a function of storing video signals supplied to the pixel electrode PX for a relatively long period.

On the upper surface of the transparent substrate SUB1 on which the counter electrodes CT are formed, a leveling film formed of an organic material layer OPAS is formed. This organic material layer OPAS is served for facilitating the rubbing treatment of an orientation film (not shown in the drawing) which is formed on an upper surface of the organic material layer OPAS due to its flatness.

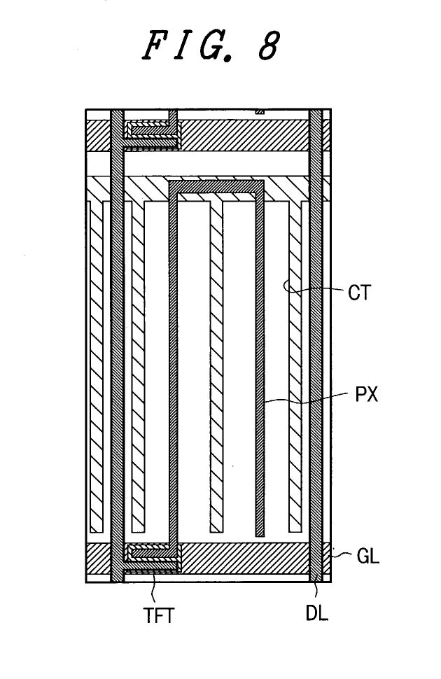

Further, FIG. 8 is a plan view showing another embodiment of the constitution of the pixel region and corresponds to FIG. 7A.

The constitution which makes this constitution different form the constitution shown in FIG. 7 in comparison lies in that the counter electrodes CT are integrally formed with the counter voltage signal line CL.

In this case, the counter electrodes CT include counter electrodes which are arranged close to the drain signal lines DL. Due to such a constitution, lines of electric force of the electric field from the drain signal lines DL are made to terminate at the neighboring counter electrodes CT and are prevented from terminating at the pixel electrode PX side.

Embodiment 2

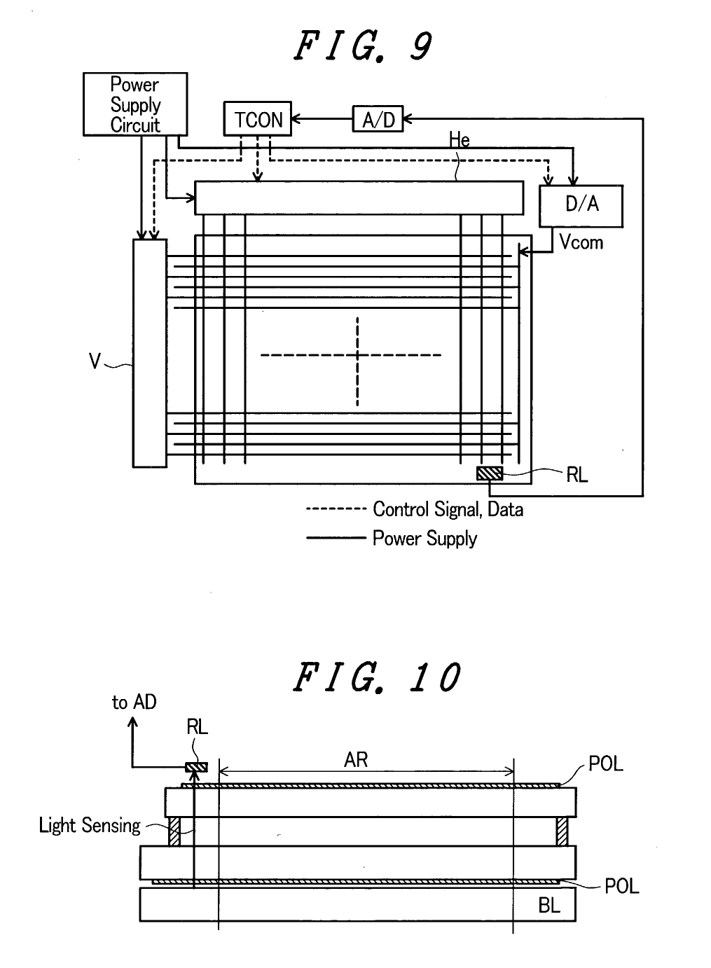

FIG. 9 is a constitutional view showing another embodiment of the liquid crystal display device according to the present invention and corresponds to FIG. 3. Further, the liquid crystal display device of this embodiment is not limited to the pixel constitution shown in FIG. 7 and FIG. 8 and is applicable to a pixel constitution in which the reference signal (Vcom) is supplied to one electrode out of a pair of electrodes formed in each pixel region.

In the drawing, a light receiving element RL which is formed of a photo diode or the like is mounted on a corner, for example, of the liquid crystal display part AR. The light receiving element RL detects the luminance of the pixel in the vicinity thereof, a detection signal is inputted to the TCON through the A/D converter, and the TCON is configured to generate an output signal based on the value of the detection signal. In response to the output signal, the reference signal (Vcom) which is obtained through the D/A converter is supplied to the counter electrode CT of each pixel region.

In this case, the TCON is configured to regulate the reference signal (Vcom) such that the luminance of each pixel is minimized when the liquid crystal display device is set to a normally black mode. Further, the TCON is configured to regulate the reference signal (Vcom) such that the luminance of each pixel is maximized when the liquid crystal display device is set to a normally white mode.

The reason is that assuming that the Vcom is deviated from the suitable Vcom voltage value, an undesired direct current voltage (DC) is superposed so that an effective value voltage of the DC component is increased whereby the luminance is increased in the normally black mode and is decreased in the normally white mode.

Here, the normally black mode is a display mode in which the display of liquid crystal assumes black when the electric field is not applied, and the normally white mode is a display mode in which the display of liquid crystal assumes white when the electric field is not applied.

FIG. 10 is a cross-sectional view showing the position where the light receiving element RL is mounted with respect to the liquid crystal display device.

A light irradiated to the light receiving element RL is a light from a backlight BL arranged on a back surface of the liquid crystal display device. The light is regulated such that the light passes through a polarizer POL1 adhered to the transparent substrate SUB1 and a polarizer POL2 adhered to the transparent substrate SUB2.

Then, the pixel region through which the light irradiated to the light receiving element RL passes through is formed in the same pattern as the pixel region which constitutes the liquid crystal display part AR. Due to such a constitution, it is possible to detect the suitable Vcom voltage value in each pixel region of the liquid crystal display part AR. In view of the above, the pixel region which allows the light irradiated to the light receiving element RL to pass therethrough may be a so-called dummy pixel region which is formed on a periphery of the liquid crystal display part AR or another pixel region which is formed separately from these pixel regions.

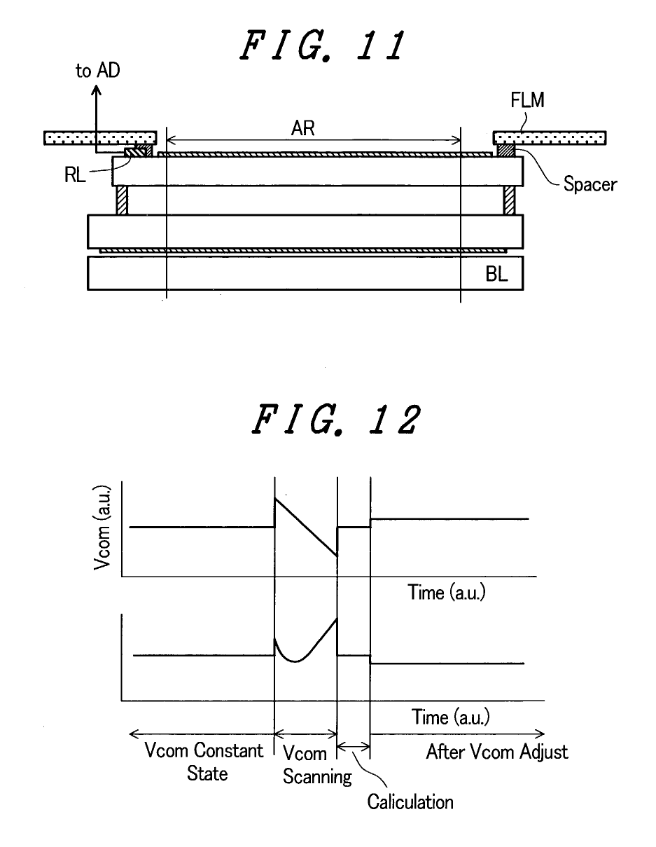

Further, FIG. 11 is a cross-sectional view showing the arrangement of the above-mentioned light receiving element when a frame FLM is provided to an observation-side surface of the liquid crystal display device.

The frame FLM is brought into contact with either one of the transparent substrates SUB1, SUB2 by way of a connection spacer in the vicinity of an opening which exposes the liquid crystal display part AR.

The light receiving element RL is formed with a thickness smaller than a thickness of the connection spacer and is arranged such that the light receiving element RL is sandwiched between the spacer and either one of the transparent substrates SUB1, SUB2.

Due to such a constitution, it is possible to obtain an advantageous effect that the light receiving element RL can be mounted simultaneously with mounting of the frame FLM.

FIG. 12 is a timing chart showing a control for setting a suitable Vcom voltage in the TCON in a normally black mode, for example.

The originally set Vcom is changed such that the Vcom is changed from a maximum value to a minimum value, for example (256→0 in case of 8 bits). Along with such a change, the change of an output from the light receiving element RL which indicates luminance is observed, the suitable Vcom voltage value is calculated based on the minimum value and, thereafter, the suitable Vcom voltage is supplied to the counter voltage signal lines CL.

It is not always necessary that the timing of Vcom adjustment is fixed. For example, since there exists a previously mentioned drift with respect to the lateral electric field type liquid crystal display device, the adjustment is performed frequently at the initial stage of the operation and, thereafter, the number of adjustment may be reduced.

The application of such a control is not limited to the lateral electric field type liquid crystal display device and the control is applicable to any type of the liquid crystal display device provided that the Vcom can be supplied to either one of a pair of electrodes which drive the liquid crystal.

Then, by applying the control to the liquid crystal display device in which the driving frequency has to cope with a plurality of modes such as a liquid crystal monitor, a liquid crystal TV or the like, it is possible to automatically adjust the suitable Vcom voltage along with the change of the mode.

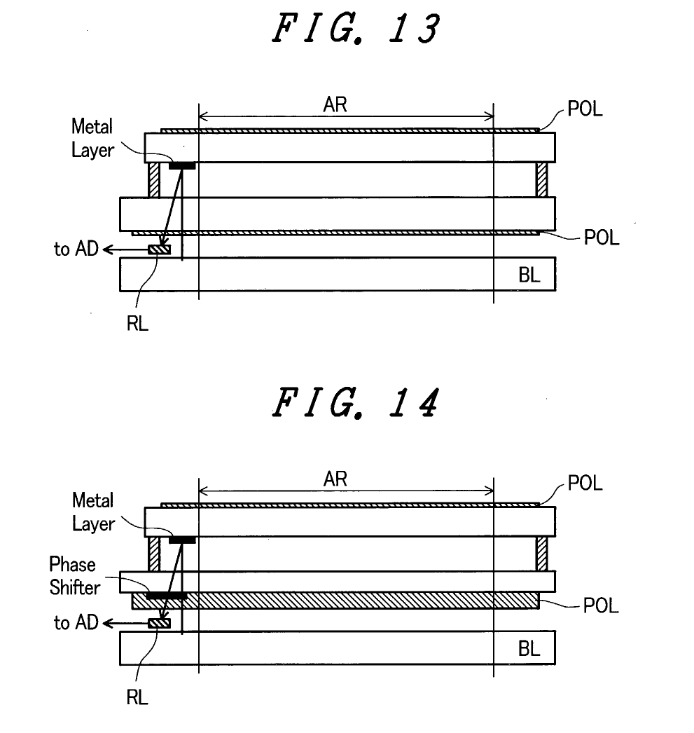

FIG. 13 is a cross-sectional view showing another embodiment of arrangement mode of the light receiving element RL. The light receiving element RL is arranged between the backlight BL and the liquid crystal panel, wherein a light from the backlight BL passes through the transparent substrate adjacent to the backlight BM, is reflected on a surface of the transparent substrate remote from the backlight BL, passes through the transparent substrate adjacent to the backlight BM again, and is irradiated to the light receiving element RL.

On a reflection portion of the surface of the transparent substrate remote from the backlight BM, a metal layer having a favorable reflectance is formed. When a black matrix is formed of a metal layer, the black matrix may be also used as such a metal layer.

Further, in the constitution shown in FIG. 14, a phase shifter is adhered to a surface of the transparent substrate at a side opposite to the liquid crystal side which is adjacent to the backlight BM and a light which advances from the backlight BM to the light receiving element RL passes through the phase shifter.

This is because that when the polarization transmission axes of the polarizers POL1, POL2 are different from each other, a light for detection passes only one-side polarizer in the detection using the reflection light and hence, the light for display assumes black in a cross nicol state (polarization transmitting axes being perpendicular to each other by 90 degrees) and the reflection light for detection assumes white in a cross nicol state.

Accordingly, when the phase shifters are disposed at an input and an output of the reflection light, the phase shifters having a phase difference of ¼ wavelength respectively are adopted, while when the phase shifter is disposed at only one of an input and an output of the reflection light, the phase shifter having a phase difference of ½ wavelength is adopted.

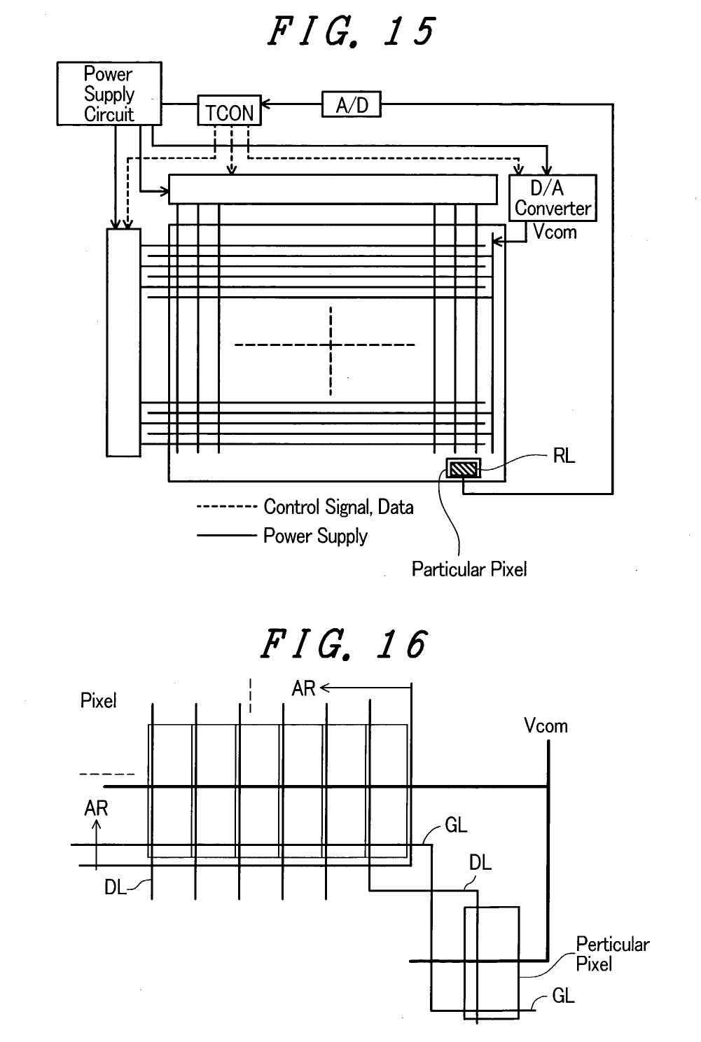

FIG. 15 is a constitutional view in which a particular pixel is formed at a portion adjacent to the liquid crystal display part AR of the liquid crystal display device and is disposed separately from the liquid crystal display part AR, and the light receiving element RL is arranged to face the particular pixel in an opposed manner.

As shown in FIG. 16, the particular pixel is configured such that the gate signal line GL, the drain signal line DL and the counter voltage signal line CL are pulled out from the liquid crystal display part AR and are led into the particular pixel so that the particular pixel has substantially the same constitution as each pixel region of the liquid crystal display part AR.

Embodiment 3

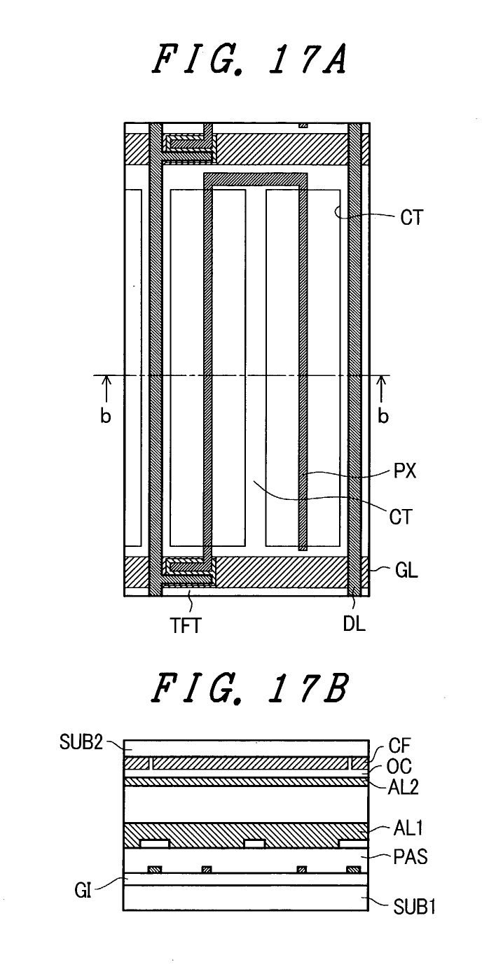

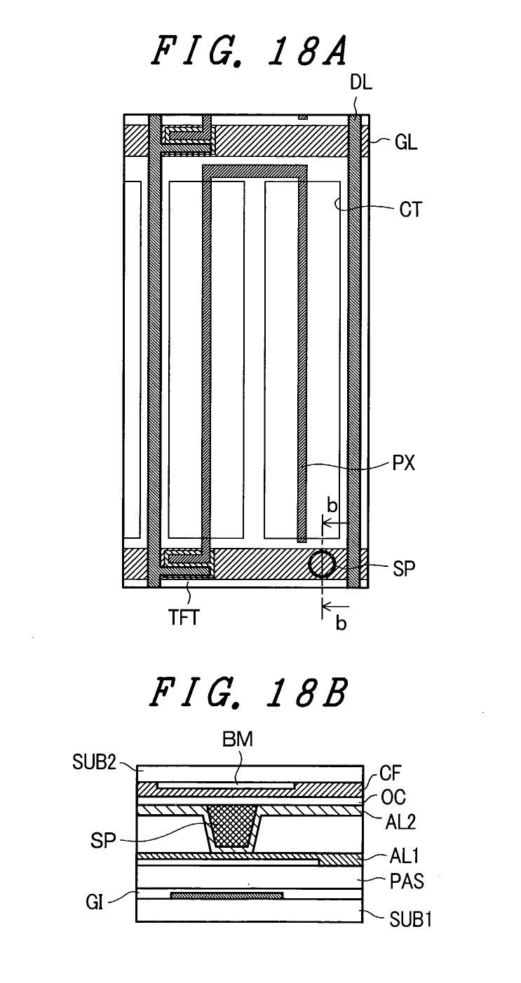

FIG. 17A is a view showing another embodiment of the liquid crystal display device according to the present invention and is also a plan view of the pixel of the liquid crystal display device. Further, FIG. 17B is a cross-sectional view taken along a line b-b in FIG. 17A.

FIG. 17A corresponds to FIG. 7A and the constitution which differs from the constitution shown in FIG. 7A lies in that orientation films AL1, AL2 have the conductivity. Here, the specific resistance of these orientation films AL1, AL2 is set to a value which falls within a range of 1×10⁹ Ωcm to 1×10¹³ Ωcm.

As can be understood from the previously-mentioned data, the storing of charge is a phenomenon which occurs on a minute basis and the polarity of the voltage in the lateral electric field for display is changed per 1 frame unit, that is, per about 10 to 20 ms.

From these data, the difference along the time axis between two phenomena becomes not less 1000 times and hence, by making use of the difference of time scale of both phenomena, it is possible to generate the normal lateral electric field and to prevent the charging-up.

Although the counter voltage signal line CL is not formed in FIG. 17A compared to the constitution shown in FIG. 7A, this does not directly affect the advantageous effect of the present invention.

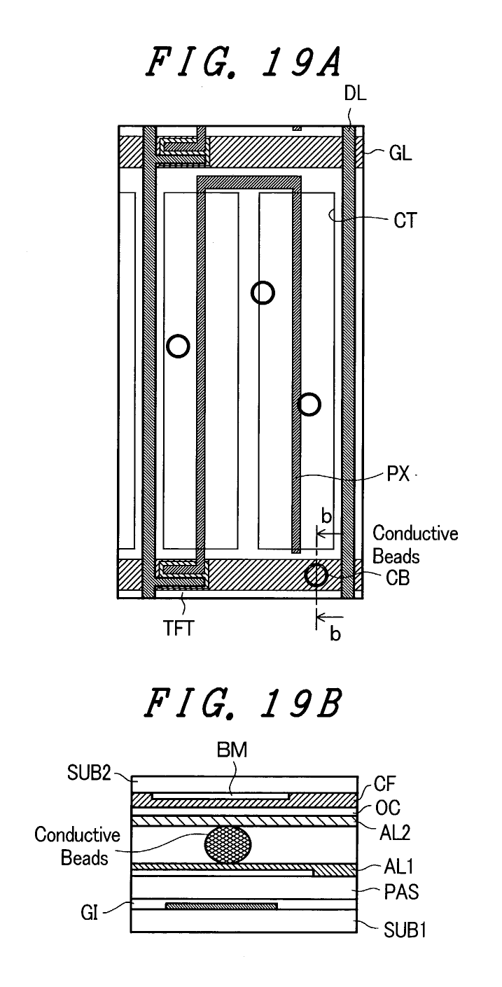

Further, as shown in FIG. 18, when the columnar spacers SP are formed on the transparent substrate SUB2 side, it is preferable that the spacers SP are covered with the orientation film AL2. Due to such a constitution, it is possible to bring the orientation film AL2 into partial contact with the orientation film AL1 at the transparent substrate SUB1 side.

That is, both of the orientation films AL1, AL2 are held in an equi-potential state and the liquid crystal LC is shielded by the equi-potential surfaces thus assuming a state in which there exists no influence of charging up. Due to such a constitution, it is possible to obviate the generation of a so-called Vcom drift phenomenon.

Further, in this embodiment, it is preferable that the counter electrode CT is formed such that the counter electrode CT is brought into contact with the orientation film AL1. Since the charge is leaked to the counter electrode CT through the orientation film AL1, it is possible to make time and effort for connecting the respective upper and lower substrates outside the pixel unnecessary as shown in JP2000-147482A, for example.

Although not to mention with respect to the orientation film AL2, the orientation film AL1 is also made conductive, the substantially same advantageous effect can be obtained even when only the orientation film AL2 is made conductive.

FIG. 19 shows a case in which conductive beads CB are used as spacers for ensuring a gap between the transparent substrates SUB1, SUB2. Also in this case, both of orientation films AL1, AL2 are held in an equi-potential state in the same manner as mentioned previously.

In the lateral electric field type liquid crystal display device of this embodiment, since the electrodes are not formed on the transparent substrate SUB2 side, there is no problem in using the conductive beads CB.

Further, since the pixel electrode PX is arranged with respect to the counter electrode CT by way of the protective film PAS, there is no fear that the respective electrodes are short-circuited due to the concentration or the like of the conductive beads CB.

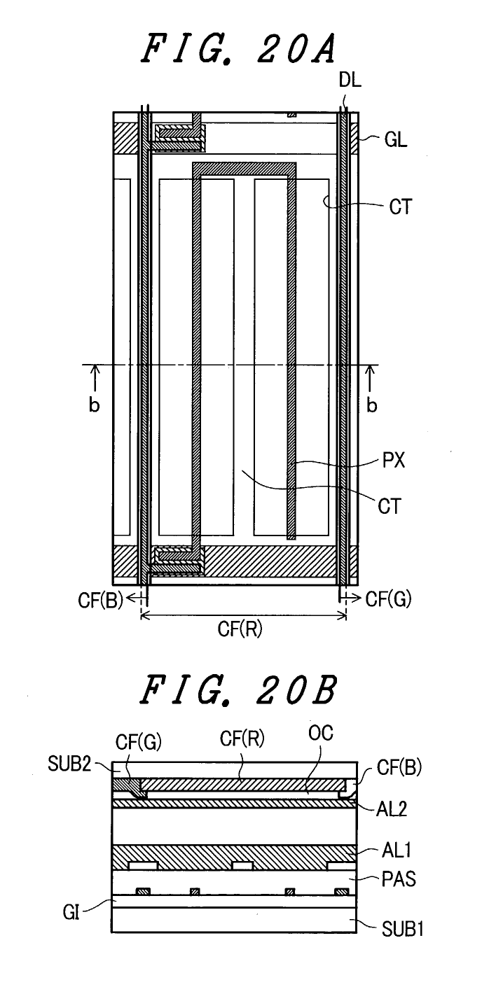

Further, as shown in FIG. 20, color filters CF having respective colors which are formed on the transparent substrate SUB2 side are configured to have conductivity and these color filters CF are connected by overlapping them to each other. Due to such a constitution, it is possible to prevent a local charging up.

In this case, even when the respective color filters CF are not connected to each other, the conductive black matrix BM may be arranged between each two color filters CF and the respective color filters CF may be electrically connected to each other by way of the black matrix BM.

Based on a similar technical concept, the leveling film OC may be configured to be conductive.

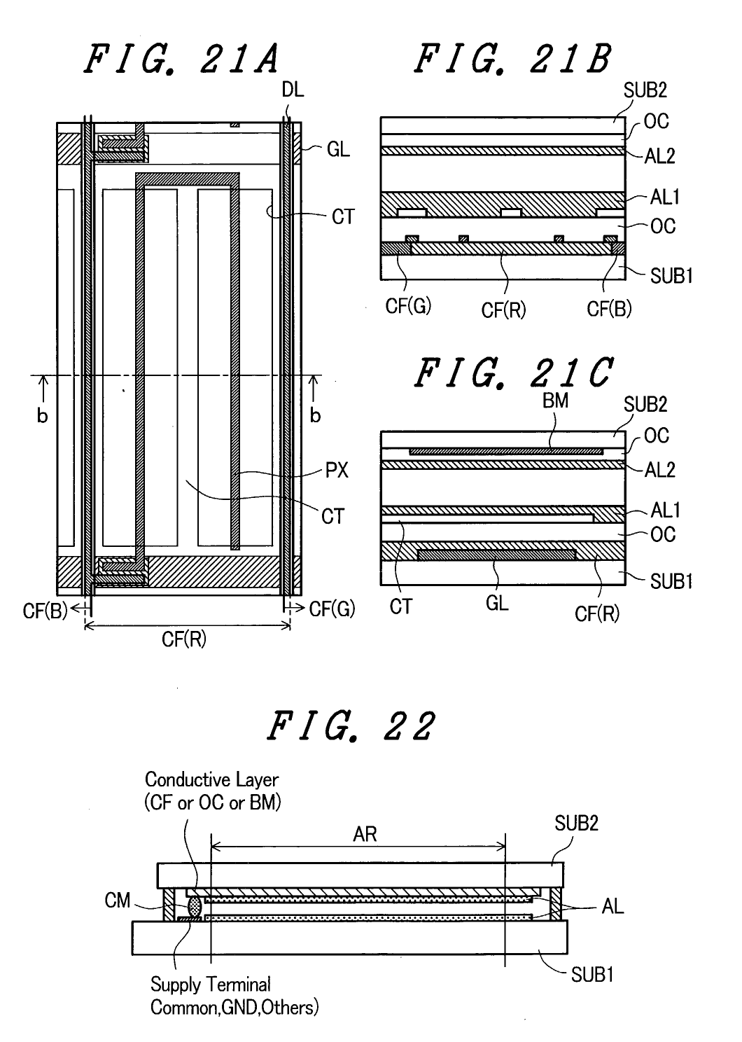

FIG. 21 is a constitutional view showing a case in which the color filters CF are formed on the transparent substrate SUB1 side. In this case, at the transparent substrate SUB2 side, the charging up is generated due to the influence of Na ions in the transparent substrate SUB2.

Accordingly, the orientation film AL2 at the transparent substrate SUB2 side is configured to have conductivity. Further, in this case, due to the relationship with the spacers SP arranged between the transparent substrates SUB1, SUB2, it is needless to say that the above-mentioned constitutions shown in FIG. 18 and FIG. 19 can be adopted.

Further, the leveling film OC may be configured to have conductivity. Still further, as shown in FIG. 21C, the conductive black matrix BM may be arranged.

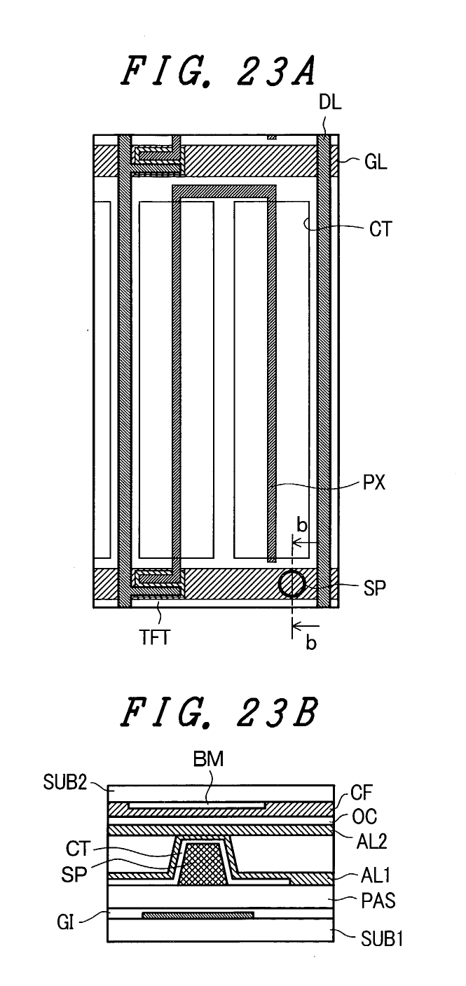

FIG. 22 shows the constitution in which electricity is supplied to at least one of the conductive orientation film AL1, the leveling film OC, the color filters CF and the black matrix BM formed on the transparent substrate SUB2 side from the outside of the liquid crystal display part AR.

As shown in the drawing, the orientation film AL1 or the like is brought into contact with one side of a connection member CM which is formed in the vicinity of a seal member SL, while another side of the connector member CM is brought into contact with a power supply terminal formed on the transparent substrate SUB1 side. The power supply terminal extends across the sealing member SL and are pulled to the outside of the sealing member SL together with the gate signal lines GL or the drain signal lines DL.

Further, in FIG. 23, the columnar spacers SP are formed on the transparent substrate SUB1 side and the counter electrode CT is formed such that the counter electrode CT covers the spacer SP. In this case, the orientation film AL2 of the transparent substrate SUB2 side is held at a potential equal to a potential of the counter electrode CT through the orientation film AL1 of the transparent substrate SUB1 side and hence, it is possible to obtain an advantageous effect that the power supply means shown in FIG. 22 is no more necessary. Further, when the static electricity is charged due to touching of a human finger, at a portion to which pressure is applied, the spacer SP is brought into further contact with the transparent substrate SUB2 by the pressure and hence, it is also possible to obtain an advantageous effect that the charge can be particularly efficiently removed when the static electricity is applied from the outside.

As can be clearly understood from the above description, according to the liquid crystal display device of the present invention, it is possible to resolve the drawbacks attributed to the charging up of a charge in another substrate which faces the substrate on which the pixel electrodes and the counter electrodes are formed in an opposed manner.

What is claimed is:

1. A liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, wherein
the liquid crystal display device further includes a control circuit which controls a voltage signal supplied to the counter electrode by taking a charge quantity which is charged to another substrate side out of the respective substrates by an electric field generated between the pixel electrode and the counter electrode into consideration.

2. A liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, wherein
the liquid crystal display device further includes a control circuit which controls a voltage signal supplied to the counter electrode, and the control circuit supplies a voltage signal set based on the influence of a charge quantity charged to another substrate side out of the respective substrates to the counter electrode.

3. A liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, wherein
the liquid crystal display device further includes a control circuit which controls a voltage signal supplied to the counter electrode, and using preset data indicative of a suitable voltage signal, the control circuit supplies a voltage signal which approximates the suitable voltage signal to the counter electrode.

4. A liquid crystal display device in which respective substrates are arranged in an opposed manner by way of liquid crystal and a pixel electrode and a counter electrode which generates an electric field between the counter electrode and the pixel electrode are formed on each one of pixel regions formed on a liquid-crystal-side surface of one substrate out of the respective substrates, wherein
a voltage supplied to the counter electrode is a voltage which is sharply changed after starting of display by the liquid crystal display device and, thereafter, assumes a stationary state.

5. A liquid crystal display device in which a pixel electrode to which a video signal is supplied and a counter electrode to which a signal constituting the reference with respect to the video signal is supplied are formed on each one of respective pixel regions arranged in a matrix array, wherein
the liquid crystal display device further includes light detection means which detects the intensity of light which is transmitted to the pixel region and control means which changes a voltage value of a signal supplied to the counter electrode in response to an output from the light detection means.

6. A liquid crystal display device according to claim 5, wherein the light detection means is arranged such that the light detection means faces a region adopting a constitution similar to the constitution of the pixel region in an opposed manner, and detects the intensity of light which is transmitted through the region.

7. A liquid crystal display device according to claim 5, wherein a voltage of the counter electrode is changed and a next counter voltage is set in response to a change of luminance which is generated at the time of changing the voltage of the counter electrode.

8. A liquid crystal display device according to claim 5, wherein the pixel electrode and the counter electrode are formed on the same substrate.

9. A liquid crystal display device according to claim 7, wherein the pixel electrode and the counter electrode are formed on the same substrate.

10. A liquid crystal display device in which respective substrates are arranged in an opposed manner by way of liquid crystal and a pixel electrode and a counter electrode are formed on each one of pixel regions formed on a liquid crystal side of one substrate out of respective substrates, wherein
at least on a liquid-crystal-side surface of another substrate out of the respective substrates, an orientation film whose specific resistance is set to a value which falls within a range of 1×10⁹ Ωcm to 1×10¹³ Ωcm is formed.

11. A liquid crystal display device according to claims 10, wherein on a liquid-crystal-side surface of the one substrate, an orientation film whose specific resistance is set to a value which falls within a range of 1×10⁹ Ωcm to 1×10¹³ Ωcm is formed.

12. A liquid crystal display device according to claims 11, wherein conductive support columns are arranged between the orientation films which are formed on one and another substrates.

13. A liquid crystal display device in which a pair of substrates which are arranged in an opposed manner by way of liquid crystal are provided, pixel electrodes and counter electrodes which generate an electric field by way of the liquid crystal are provided, and a potential of the pixel electrodes is set such that a video signal is supplied to video signal lines from a video signal driving circuit by way of thin film transistors in response to a scanning signal which is supplied to scanning signal lines from a scanning signal driving circuit, wherein
the video signal driving circuit and the scanning signal driving circuit are controlled in response to signals from a controller, and the liquid crystal display device further includes a D/A converter which generates a counter voltage supplied to the counter electrodes in response to the signals from the controller.

14. A liquid crystal display device according to claim 13, wherein a Low voltage supplied to the D/A converter is higher than the lowest voltage supplied to the video signal driving circuit, and a High voltage supplied to the D/A converter is lower than the highest voltage supplied to the video signal driving circuit.

15. A liquid crystal display device according to claim 13, wherein a current amplifying circuit is provided between the D/A converter and the counter electrodes.

16. A liquid crystal display device according to claim 13, wherein the pixel electrodes and the counter electrodes are formed on the same substrate.

17. A liquid crystal display device according to claim 16, wherein the counter voltage is controlled by taking a charge quantity charged to another substrate side out of the respective substrates due to an electric field generated between the pixel electrodes and the counter electrodes into account.

18. A liquid crystal display device according to claim 16, wherein the counter voltage is served for supplying a voltage signal set in view of the influence of a charge quantity charged to another substrate side out of the respective substrates to the counter electrodes.

19. A liquid crystal display device according to claim 16, wherein the counter voltage is a voltage which is generated using preset data indicative of a suitable voltage signal such that the counter voltage approximates the suitable voltage signal.

20. A liquid crystal display device according to claim 16, wherein the liquid crystal display device includes light detection means which detects the intensity of light which is transmitted through the liquid crystal display device and control means which changes a voltage value of a signal supplied to the counter electrodes in response to an output from the light detection means.
